(19) United States
(12) Patent Application Publication
(10) Pub. No.: US 2015/0264064 A1
(43) Pub. Date: Sep. 17, 2015

(54) METHOD AND SYSTEM FOR FILTERING SPAM MESSAGES ON PURCHASE PREFERENCES

(71) Applicant: MASTERCARD INTERNATIONAL INCORPORATED, Purchase, NY (US)

(72) Inventor: Jean-Pierre GERARD, Croton-On-Hudson, NY (US)

(73) Assignee: MASTERCARD INTERNATIONAL INCORPORATED, Purchase, NY (US)

(21) Appl. No.: 14/215,934

(22) Filed: Mar. 17, 2014

(51) Int. Cl. H04L 29/06; G06Q 30/02

(52) U.S. Cl. CPC H04L 63/1408; G06Q 30/0241

(57) ABSTRACT

A method for unblocking spam email messages includes: storing, in an email database, a plurality of email data entries, wherein each email data entry includes data related to an email message including at least message data, content data, and an indication of spam; receiving, by a receiving device, consumer data associated with one or more consumers, wherein the consumer data is based on transaction data for one or more payment transactions involving the associated one or more consumers; identifying, in the email database, one or more email data entries where the included content data corresponds to the received consumer data; and transmitting, by a transmitting device, at least the message data included in each of the identified one or more email data entries.

### FIELD

The present disclosure relates to the unblocking of spam messages, specifically the use of purchase behavior to identify false positives or to unblock spam messages that should not be marked as spam for a consumer.

### BACKGROUND

Traditional mail provided for an easy and effective way for people and businesses to communicate with one another. Mail delivery became so efficient and effective that many businesses began to utilize mail as a way to distribute advertisements and other content to potential consumers. However, without a suitable way to appropriately filter mail content, many consumers would often receive unwarranted advertisements and mail from various sources.

As the Internet gained widespread use, many consumers and businesses turned to email as a preferred method of communication over traditional mail. Email provided for a number of advantages over traditional mail, such as immediate or near-immediate delivery, the ability to attach large documents or files without special packaging or increased fees, as well as the ability to quickly organize and categorize incoming messages. However, like with traditional mail, the submission of unwarranted and, in many instances unwanted, email messages, often referred to as “spam” messages, to consumers began to occur. These types of messages

[symbol]

Taking advantage of the functionality of computers and computing systems, many methods and systems were developed to filter out messages that were identified as spam, such as based on content included in the message, the email address of the sender of the message, or an internet protocol (IP) address or other identifier indicated as the source of the message. However, while such systems and methods may be effective at blocking spam messages, these systems and methods may often also block messages that are not spam, or block unwarranted messages that may actually be of interest to the recipient.

Thus, there is a need for a technical solution to provide for systems and methods for unblocking genuine messages falsely identified as spam and for unblocking spam messages that may be of interest to the recipient based on the recipient's purchasing history.

### SUMMARY

The present disclosure provides a description of systems and methods for the unblocking of spam email messages.

A method for unblocking spam email messages includes: storing, in an email database, a plurality of email data entries, wherein each email data entry includes data related to an email message including at least message data, content data, and an indication of spam; receiving, by a receiving device, consumer data associated with one or more consumers, wherein the consumer data is based on transaction data for one or more payment transactions involving the associated one or more consumers; identifying, in the email database, one or more email data entries where the included content data corresponds to the received consumer data; and transmitting, by a transmitting device, at least the message data included in each of the identified one or more email data entries.

Another method for unblocking spam email messages includes: storing, in an email database, a plurality of email data entries, wherein each email data entry includes data related to an email message including at least message data, content data, and an indication of spam; storing, in a transaction database, a plurality of transaction data entries, wherein each transaction data entry includes data related to a payment transaction involving a consumer including at least transaction data; identifying, by a processing device, a consumer behavior model associated with the consumer based on the transaction data included in each transaction data entry stored in the transaction database; identifying, in the email database, one or more email data entries based on a correspondence between the included content data and the identified consumer behavior model; and transmitting, by a transmitting device, at least the message data included in each of the identified one or more email data entries.

A system for unblocking spam email messages includes an email database, a receiving device, a processing device, and a transmitting device. The email database is configured to store a plurality of email data entries, wherein each email data entry includes data related to an email message including at least message data, content data, and an indication of spam. The receiving device is configured to receive consumer data associated with one or more consumers, wherein the consumer data is based on transaction data for one or more payment transactions involving the associated one or more consumers. The processing device is configured to identify, in the email database, one or more email data entries where the included content data corresponds to the received consumer data. The transmitting device is configured to transmit at least the message data included in each of the identified one or more email data entries.

Another system for unblocking spam email messages includes an email database, a transaction database, a processing device, and a transmitting device. The email database is configured to store a plurality of email data entries, wherein each email data entry includes data related to an email message including at least message data, content data, and an indication of spam. The transaction database is configured to store a plurality of transaction data entries, wherein each transaction data entry includes data related to a payment transaction involving a consumer including at least transaction data. The processing device is configured to: identify a consumer behavior model associated with the consumer based on the transaction data included in each transaction data entry stored in the transaction database; and identify, in the email database, one or more email data entries based on a correspondence between the included content data and the identified consumer behavior model. The transmitting device is configured to transmit at least the message data included in each of the identified one or more email data entries.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level architecture illustrating a system for unblocking spam email messages in accordance with exemplary embodiments.

FIG. 2 is a block diagram illustrating the processing server of FIG. 1 for the unblocking of spam email messages in accordance with exemplary embodiments.

FIG. 3 is a flow diagram illustrating a process for unblocking spam email messages using consumer purchase history using the system of FIG. 1 accordance with exemplary embodiments.

FIG. 4 is a flow diagram illustrating a process for unblocking spam email messages based on consumer purchase history using the processing server of FIG. 2 in accordance with exemplary embodiments.

FIGS. 5 and 6 are flow charts illustrating exemplary methods for unblocking spam email messages in accordance with exemplary embodiments.

FIG. 7 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Definition of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

### System for Unblocking Spam Email Messages

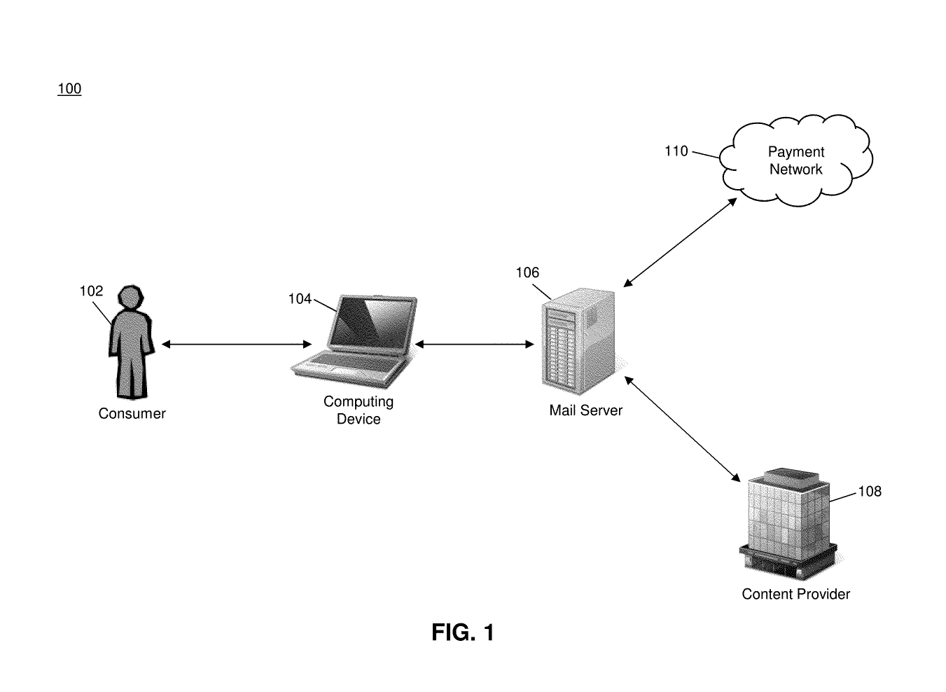

FIG. 1 illustrates a system 100 for the prediction of consumer behavior based on installment payments.

The system 100 may include a consumer 102. The consumer 102 may use a computing device 104 to receive email messages. The computing device 104 may be a desktop computer, laptop computer, notebook computer, tablet computer, cellular phone, smart phone, or any other device suitable for receiving email messages as will be apparent to persons having skill in the relevant art. The computing device 104 may receive the email messages from one or more mail servers 106.

Each mail server 106, discussed in more detail below, may be configured to receive email messages from a plurality of sources, such as from other computing devices 104 operated by other consumers 102. For example, the mail server 106 may be configured to receive email messages from one consumer 102 via their consumer device 104 for delivery to another consumer 102 via the other consumer's computing device 104. Methods and systems for receiving and delivering email messages will be apparent to persons having skill in the relevant art.

The mail server 106 may be configured to receive email messages from one or more content providers 108. The mail server 106 may be configured to filter email messages received from the content providers 108 to identify email messages indicative of spam. Methods for identifying email messages indicative of spam will be apparent to persons having skill in the relevant art and may utilize content filtering, email address filtering, IP address filtering, filtering based on consumer preferences, etc. The mail server 106 may then deliver the email messages to the computing device 104 of the consumer 102, with email messages identified as indicative of spam being indicated to the consumer 102. For example, an application program executed by the computing device 104 and used to view the received email messages may present the email messages identified as spam in a different location than email messages not identified as spam.

As discussed in more detail below, the mail server 106 may also be configured to unblock messages initially identified as being indicative of spam based on purchase history of the consumer 102. The mail server 106 may receive transaction data for a plurality of payment transactions involving the consumer 102 from a payment network 110. The payment network 110 may be configured to process payment transactions, and may store transaction data for the processed payment transactions. The payment network 110 may provide the transaction data associated with payment transactions involving the consumer 102 to the mail server 106. Payment transactions involving the consumer 102 may be based on information associated with the consumer, such as a payment account number, consumer identifier, or other value suitable for identification. The transaction data may include product data, merchant data, consumer data, transaction amounts, transaction time and/or dates, and other data that may be suitable for use in performing the functions as disclosed herein.

In some embodiments, the consumer 102 may be a part of a microsegment of consumers. A microsegment may be a group of consumers that is granular enough to be valuable to advertisers, marketers, offer providers, merchants, retailers, etc., but still maintain a high level of consumer privacy without the use or obtaining of personally identifiable information. Additional information regarding microsegments may be found in U.S. patent application Ser. No. 13/437,987, entitled “Protecting Privacy in Audience Creation,” by Curtis Villars et al., filed on Apr. 3, 2012, which is herein incorporated by reference in its entirety. In such an embodiment, the payment network 110 may identify transaction data for payment transactions associated with the microsegment of consumers that includes the consumer 102 for providing to the mail server 106. In such an embodiment, the mail server 106 may receive transaction data associated with the consumer 102 while maintaining consumer privacy and anonymity.

The mail server 106 may identify a consumer behavior model associated with the consumer 102 based on the transaction data. The mail server 106 may then identify email messages that were identified as indicative of spam that should be unblocked based on message data or content data of the email messages and the identified consumer behavior model associated with the consumer 102. The mail server 106 may update the identified email messages to no longer be indicative of spam, and then deliver the messages to the computing device 104.

It will be apparent to persons having skill in the relevant art that the methods and systems discussed herein for unblocking spam email messages may be performed by any suitable computing device. For example, although the systems and methods discussed herein are illustrated as being performed by the mail server 106, such methods and systems may alternatively or additional be performed by the computing device 104 or other suitable device.

The use of transaction data of a consumer 102 to unblock spam email messages may be beneficial in the elimination of false positive identification of spam email messages. For example, the mail server 106 may initially identify an email message from a particular merchant as spam, but may unblock the message upon analyzing the transaction data and seeing that the consumer 102 recently made a purchase from the same merchant. By analyzing the transaction data, the email message may be delivered to the consumer 102 when it otherwise may have been false positively identified as spam.

The analysis of the transaction data of the consumer 102 to unblock spam email messages may also be beneficial in unblocking email messages that may be favorably viewed by the consumer 102. For example, the transaction data for the consumer 102 or a microsegment including the consumer 102 may indicate that the consumer 102 has an appreciation for high-end consumer electronics. The mail server 106 may thus unblock an email message flagged as spam that contains an offer or discount for a new high-end consumer electronic or a press release regarding a brand new offering that is in line with the consumers tastes based on their purchases.

### Mail Server

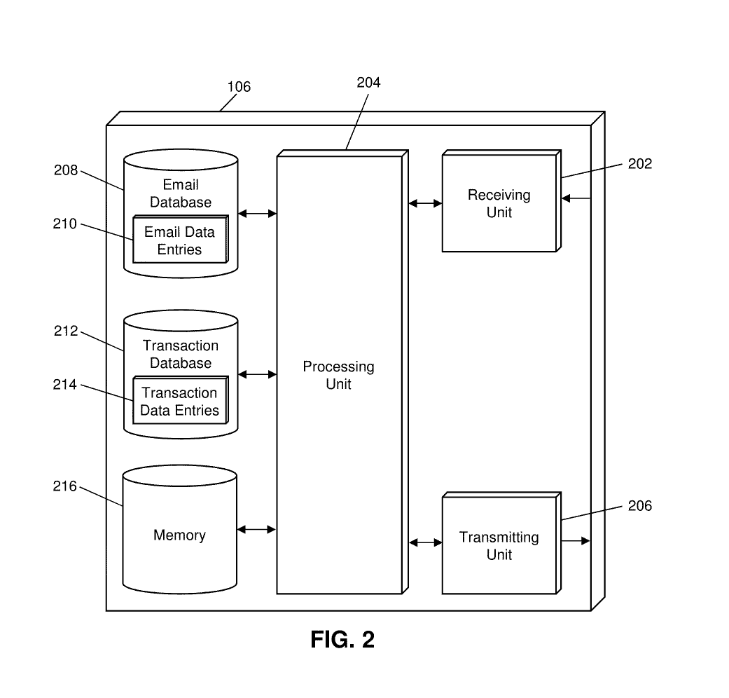

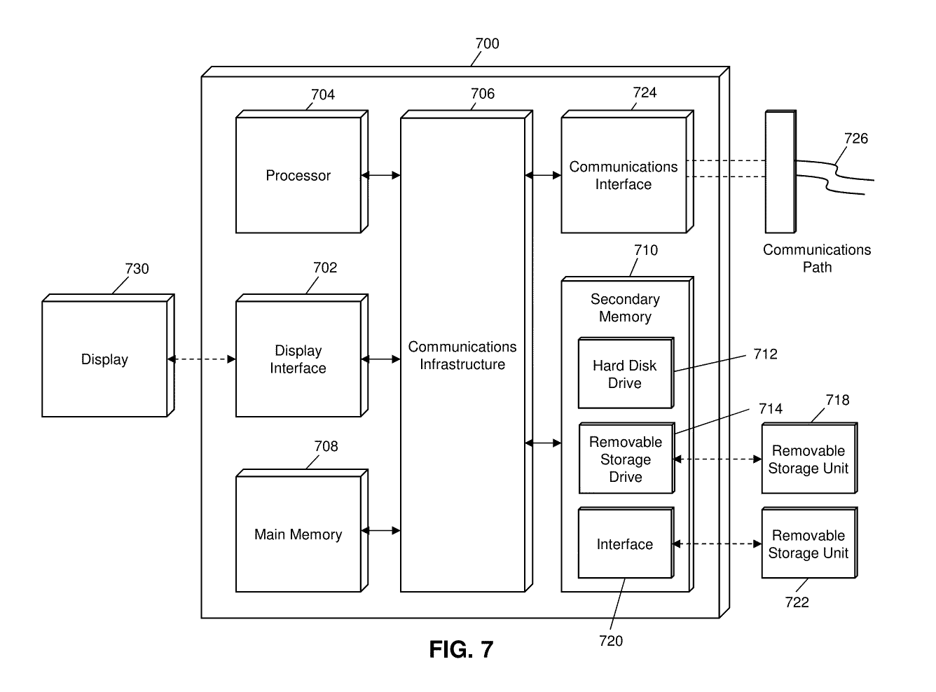

FIG. 2 illustrates an embodiment of the mail server 106 of the system 100. It will be apparent to persons having skill in the relevant art that the embodiment of the mail server 106 illustrated in FIG. 2 is provided as illustration only and may not be exhaustive to all possible configurations of mail server 106 suitable for performing the functions as discussed herein. For example, the computer system 700 illustrated in FIG. 7 and discussed in more detail below may be a suitable configuration of the mail server 106. It will also be apparent to persons having skill in the relevant art that the components illustrated in the mail server 106 as illustrated in FIG. 2 and functions performed thereof may alternatively or additionally be included in the computing device 104, which may be configured to perform the functions discussed below.

The mail server 106 may include a receiving unit 202. The receiving unit 202 may be configured to receive data over one or more networks via one or more network protocols. The receiving unit 202 may be configured to receive email messages from multiple sources, such as computing devices 104 and content providers 108. The mail server 106 may also include a processing unit 204. The processing unit 204 may be configured to store the received email messages in an email database 208. Each email message may be stored in the email database 208 as a separate email data entry 210.

Each email data entry 210 may include data related to the email message including at least message data, content data, and an indication of spam. The message data may include header information, such as the deliverer of the message the recipient of the message, the subject, the body of the message, attachments, etc. The content data may include data regarding the content of the related email message, such as categories, criteria, or other data that may be suitable for use in the methods and systems discussed herein. The indication of spam may be a flag that indicates if the related email message is identified as spam or not. In some embodiments, the processing unit 204 may identify email messages related to stored email data entries 210 as being indicative of spam, and update the corresponding flag stored therein, upon receipt by the receiving unit 202 using methods and systems that will be apparent to persons having skill in the relevant art.

The receiving unit 202 may also be configured to receive consumer data associated with one or more consumers, such as the consumer 102. The consumer data may be based on transaction data for one or more payment transactions involving the associated one or more consumers. In some embodiments, the one or more consumers may be a microsegment of consumers. The consumer data may include a consumer behavior model based on the transaction data and may also include consumer-provided data, such as preferences and content specified by the associated one or more consumers for use in unblocking spam email messages.

In some embodiments, the processing unit 204 may be configured to identify the consumer data associated with the one or more consumers, such as the consumer behavior models, based on transaction data. In such an embodiment, the receiving unit 202 may be configured to receive transaction data for a plurality of payment transactions involving the consumers 102 from the payment network 110. The processing unit 204 may store the transaction data in a transaction database 212. The transaction database 212 may include the stored transaction data as a plurality of transaction data entries 214, each transaction data entry 214 including data related to a payment transaction including at least transaction data. The transaction data may include merchant data, product data, consumer data, a transaction amount, transaction time and/or date, geographic location, etc.

The processing unit 204 may be configured to identify a consumer behavior model based on the transaction data included in each transaction data entry 214 associated with a consumer 102 or a microsegment of consumers including the consumer 102. The consumer behavior model may include, for example, propensities for spending for the consumer 102 for a plurality of categories, merchants, industries, etc., purchase behaviors, spending behaviors, geographic location preferences, etc.

The processing unit 204 may also be configured to identify one or more email data entries 210 that should be unblocked based on the consumer data. The processing unit 204 may identify the one or more email data entries 210 based on correspondence between the consumer data associated with the consumer 102 and the content data included in the one or more email data entries 210. The processing unit 204 may then update the indication of spam in the identified one or more email data entries 210 to indicate that the email message is not flagged as spam.

The mail server 106 may also include a transmitting unit 206. The transmitting unit 206 may be configured to transmit data over one or more networks via one or more network protocols. The transmitting unit 206 may transmit the email messages related to each of the email data entries 210 stored in the email database 208 to the computing device 104 indicated as a recipient in the header data of the email message. In some embodiments, the transmitting unit 206 may only transmit the identified one or more email data entries 210 that corresponded to the consumer data and were unblocked.

In some instances, the receiving unit 202 may be configured to receive feedback from the consumer 102. The feedback may be provided by the consumer 102 regarding email messages that were unblocked, consumer preferences as to content that should be blocked or unblocked, and other feedback that may be suitable for performing the functions disclosed herein as will be apparent to persons having skill in the relevant art. The processing unit 204 may be configured to use the received feedback data in addition to the consumer data to identify email data entries 210 for unblocking. In some embodiments, the processing unit 204 may update the consumer behavior model associated with a consumer 102 based on the received feedback data.

### Process for Unblocking Spam Email Messages

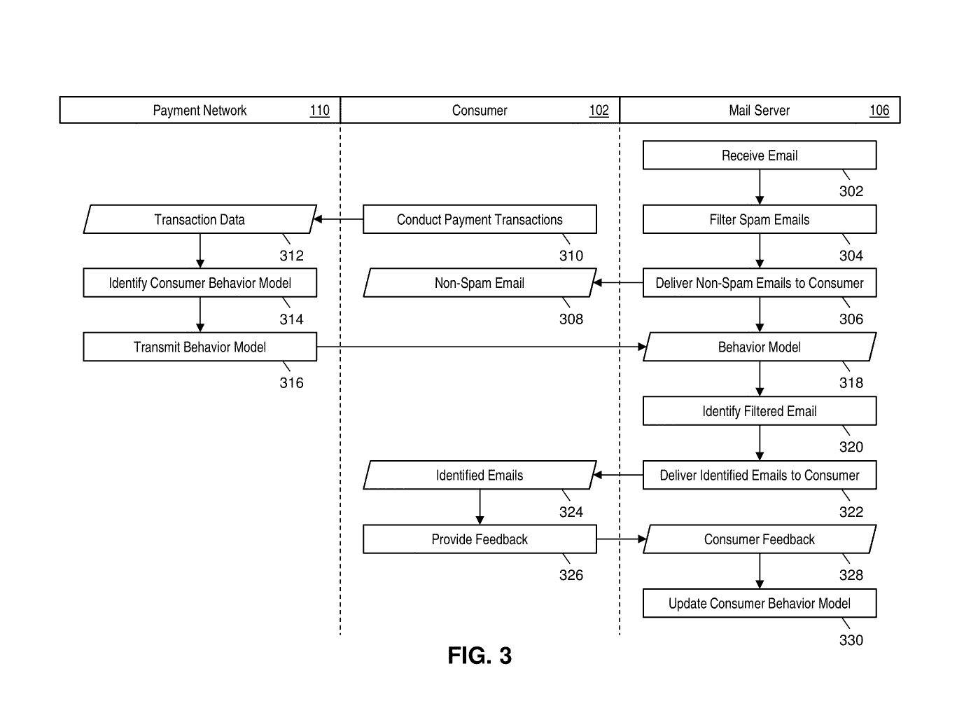

FIG. 3 illustrates a process for unblocking spam email messages based on consumer data using the system 100 of FIG. 1.

In step 302, the receiving unit 202 of the mail server 106 may receive email messages, such as from content providers 108 and computing devices 104. The processing unit 204 of the mail server 106 may store the received email messages as a plurality of email data entries 210 in the email database 208. In step 304, the processing unit 204 may filter emails identified as spam using methods and systems that will be apparent to persons having skill in the final art. In some embodiments, the processing unit 204 may flag the identified email messages as spam in the respective email data entries 210 using the included indication of spam.

In step 306, the transmitting unit 206 of the mail server 106 may transmit email messages that are not identified as spam to the computing device 104 associated with the consumer 102, which may be received by the consumer 102, at step 308. In step 310, the consumer 102 may conduct payment transactions with one or more merchants. In step 312, the payment network 110 may receive transaction data for payment transactions conducted by the consumer 102, such as received during processing of the payment transactions.

In step 314, the payment network 110 may (e.g., using one or more computing devices) identify a consumer behavior model to be associated with the consumer 102 based on the transaction data for the payment transactions involving the consumer 102. In step 316, the payment network 110 may transmit the identified consumer behavior model to the mail server 106 as consumer data. In step 318, the receiving unit 202 may receive the consumer data including the identified consumer behavior model.

In step 320, the processing unit 204 may filter the email messages identified as spam based on the received consumer data including the consumer behavior model for the consumer 102. Filtering the email messages may include identifying email messages that should no longer be identified as spam based on the consumer behavior model and the content data included in the respective email data entries 210, and updating the indication of spam included in the respective email data entries 210 accordingly. In step 322, the identified email messages may be transmitted to the computing device 104 of the consumer 102 by the transmitting unit 206.

In step 324, the consumer 102 may receive the unblocked email messages on their computing device 104. In step 326, the consumer 102 may provide input as to feedback regarding the received email messages using the computing device 104. The feedback data may be received by the receiving unit 202 of the mail server 106, in step 328. The consumer feedback data may include user preferences or feedback regarding the email messages that were not identified as spam or that were unblocked, or regarding email messages wrongly identified as spam. In step 330, the processing unit 204 may update the consumer behavior model of the consumer 102 based on the feedback data.

### Exemplary Process for Unblocking Spam Email Messages Using Transaction Data

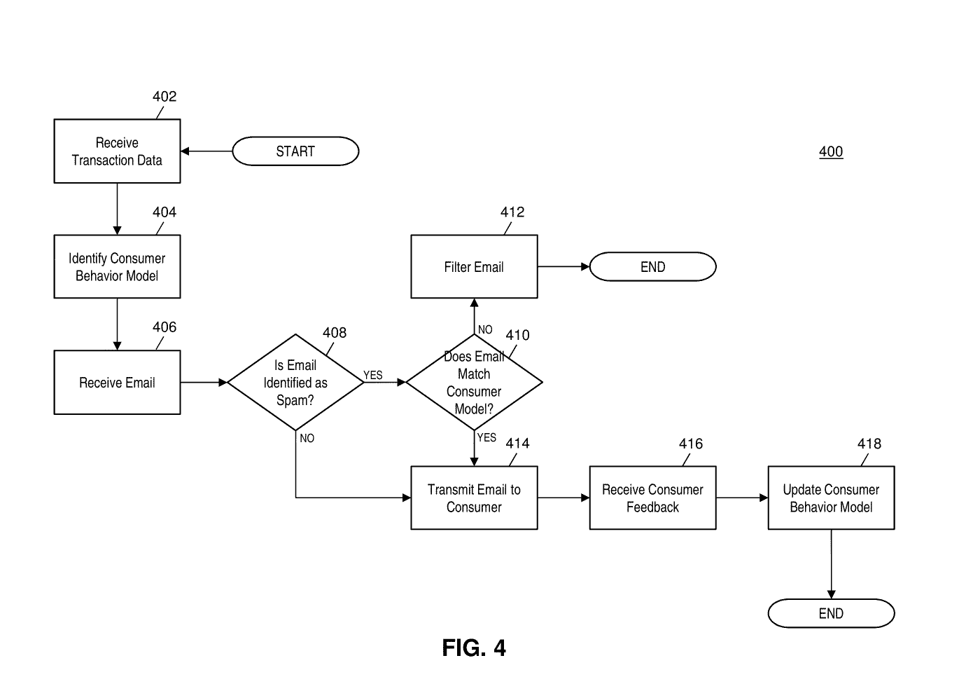

FIG. 4 illustrates a process 400 for the unblocking of email messages identified as spam based on transaction data for a consumer 102.

In step 402, the receiving unit 202 of the mail server 106 may receive transaction data for a plurality of payment transactions involving the consumer 102. The transaction data may include merchant data, product data, consumer data, transaction amounts, transaction times and/or dates, geographic locations, or other data suitable for performing the functions disclosed herein. In some embodiments, the processing unit 204 may store the received transaction data as a plurality of transaction data entries 214 in the transaction database 212 of the mail server 106.

In step 404, the processing unit 204 of the mail server 106 may identify a consumer behavior model associated with the consumer 102 based on the received transaction data. In step 406, the receiving unit 202 may receive an email message to be delivered to the consumer 102, with the email message including at least message data and content data. In step 408, the processing unit 204 may determine if the email message is spam using traditional methods and systems for identifying spam email messages. If the email is identified as spam, then, in step 410, the processing unit 204 may determine if there is a correspondence between the content data of the email message and the consumer behavior model.

If there is no correspondence between the content data and the consumer behavior model, then, in step 412, the email message may continue to be filtered out as spam. The email message may then be processed (e.g., organized, quarantined, delivered, etc.) using methods and systems that will be apparent to persons having skill in the relevant art for handling spam email messages. If there is a correspondence between the content data and the consumer behavior model, then the processing unit 204 may unblock the email message or otherwise indicate that it is not spam. For email messages that are unblocked, or were not initially identified as spam, in step 414 the transmitting unit 206 of the mail server 106 may transmit the email message to the computing device 104 of the consumer 102.

In step 416, the receiving unit 202 may receive consumer feedback regarding the transmitted email message. The consumer feedback may indicate approval or disapproval of the email message being not identified as spam or unblocked based on the consumer behavior model. In some embodiments, the consumer feedback may be a discrete value (e.g., approval or disapproval, like or dislike, etc.), while, in other embodiments, the consumer feedback may be a value on a scale, such as a rating on a scale of 1 to 100. Methods and systems for providing consumer feedback will be apparent to persons having skill in the relevant art. In step 418, the processing unit 204 may update the consumer behavior model based on the consumer feedback.

### First Exemplary Method for Unblocking Spam Email Messages

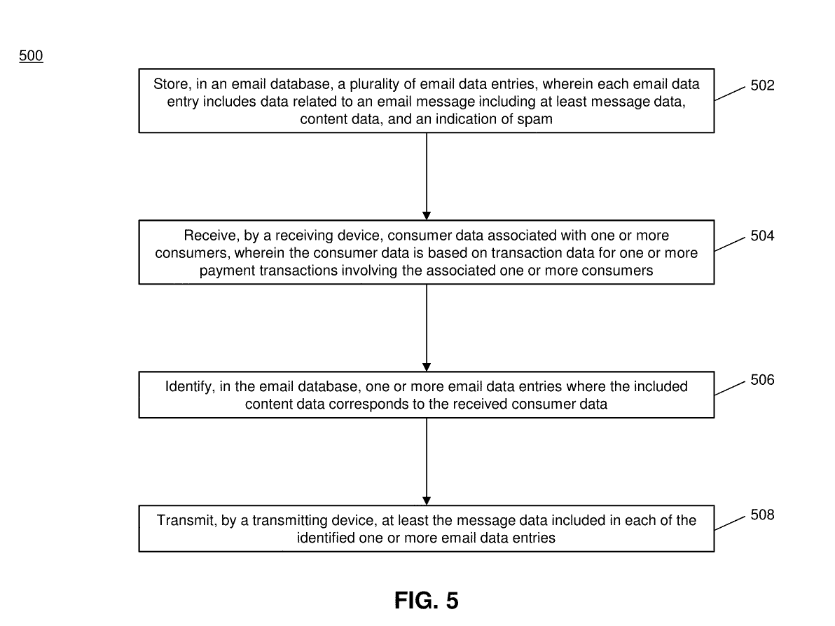

FIG. 5 illustrates a method 500 for unblocking spam email messages based on consumer data.

In step 502, a plurality of email data entries (e.g., email data entries 210) may be stored in an email database (e.g., the email database 208), wherein each email data entry 210 includes data related to an email message including at least message data, content data, and an indication of spam.

In step 504, consumer data associated with one or more consumers (e.g., consumers 102) may be received by a receiving device (e.g., the receiving unit 202), wherein the consumer data is based on transaction data for one or more payment transactions involving the one or more consumers 102. In one embodiment, the content data may include at least an email address associated with a destination of the related email message, and the received consumer data may include one or more consumer email addresses. In some embodiments, the one or more consumers 102 may be included in a microsegment of consumers. In one embodiment, the consumer data may include data related to feedback provided by the associated one or more consumers 102.

In step 506, one or more email data entries 210 may be identified in the email database 208 where the included content data corresponds to the received consumer data. In some embodiments, the received consumer data may include a consumer behavior model corresponding to the associated one or more consumers 102, the consumer behavior model being based on the transaction data for one or more payment transactions involving the one or more consumers 102, and the correspondence between the included content data of the one or more email data entries 210 and the received consumer data may be based on at least the consumer behavior model. In one embodiment, the consumer data may include specified content data, and the content data included in each of the identified one or more email data entries 210 may correspond to the specified content data.

In step 508, at least the message data included in each of the identified one or more email data entries 210 may be transmitted by a transmitting device (e.g., the transmitting unit 206).

### Second Exemplary Method for Unblocking Spam Email Messages

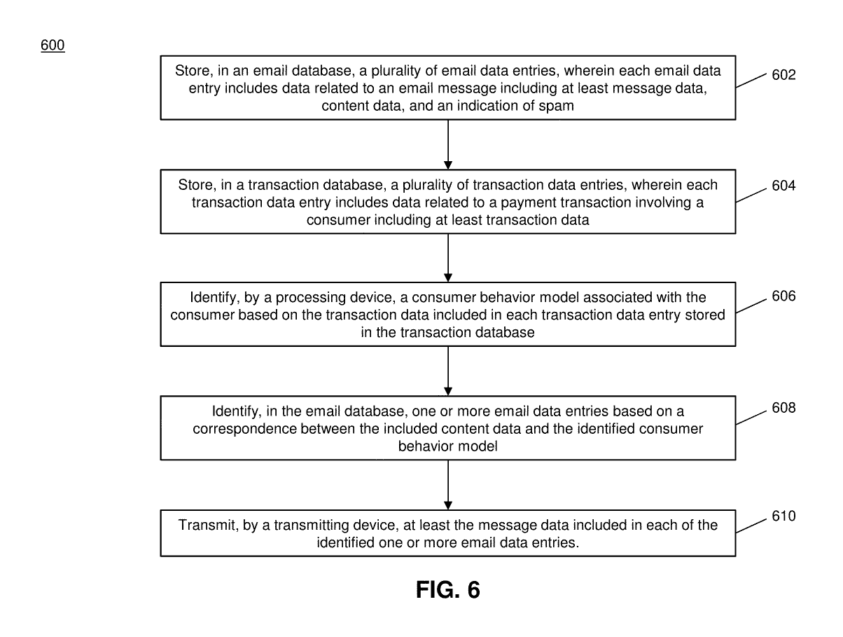

FIG. 6 illustrates a method 600 for unblocking spam email messages based on transaction data.

In step 602, a plurality of email data entries (e.g., email data entries 210) may be stored in an email database (e.g., the email database 208), wherein each email data entry 210 includes data related to an email message including at least message data, content data, and an indication of spam.

In step 604, a plurality of transaction data entries (e.g., transaction data entries 214) may be stored in a transaction database (e.g., the transaction database 212), wherein each transaction data entry 214 includes data related to a payment transaction involving a consumer (e.g., the consumer 102) including at least transaction data. In one embodiment, the consumer 102 may one of a microsegment of consumers. In some embodiments, the transaction data may include at least one of: product data, merchant data, and consumer data.

In step 606, a consumer behavior model associated with the consumer 102 may be identified by a processing device (e.g., the processing unit 204) based on the transaction data included in each transaction data entry 214 stored in the transaction database 212. In step 608, one or more email data entries 210 may be identified in the email database 208 based on a correspondence between the included content data and the identified consumer behavior model.

In step 610, at least the message data included in each of the identified one or more email data entries may be transmitted by a transmitting device (e.g., the transmitting unit 206). In one embodiment, the method 600 may further include receiving, by a receiving device (e.g., the receiving unit 202) feedback data from the consumer 102, wherein the identified consumer behavior model associated with the consumer 102 is further based on the received feedback data.

### Computer System Architecture

FIG. 7 illustrates a computer system 700 in which embodiments of the present disclosure, or portions thereof, may be implemented as computer-readable code. For example, the computing device 104 or mail server 106 of FIG. 1 may be implemented in the computer system 700 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3-6.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 718, a removable storage unit 722, and a hard disk installed in hard disk drive 712.

Various embodiments of the present disclosure are described in terms of this example computer system 700. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 704 may be a special purpose or a general purpose processor device. The processor device 704 may be connected to a communications infrastructure 706, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 700 may also include a main memory 708 (e.g., random access memory, read-only memory, etc.), and may also include a secondary memory 710. The secondary memory 710 may include the hard disk drive 712 and a removable storage drive 714, such as a floppy disk drive, a magnetic tape drive, an optical disk drive, a flash memory, etc.

The removable storage drive 714 may read from and/or write to the removable storage unit 718 in a well-known manner. The removable storage unit 718 may include a removable storage media that may be read by and written to by the removable storage drive 714. For example, if the removable storage drive 714 is a floppy disk drive or universal serial bus port, the removable storage unit 718 may be a floppy disk or portable flash drive, respectively. In one embodiment, the removable storage unit 718 may be non-transitory computer readable recording media.

In some embodiments, the secondary memory 710 may include alternative means for allowing computer programs or other instructions to be loaded into the computer system 700, for example, the removable storage unit 722 and an interface 720. Examples of such means may include a program cartridge and cartridge interface (e.g., as found in video game systems), a removable memory chip (e.g., EEPROM, PROM, etc.) and associated socket, and other removable storage units 722 and interfaces 720 as will be apparent to persons having skill in the relevant art.

Data stored in the computer system 700 (e.g., in the main memory 708 and/or the secondary memory 710) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 700 may also include a communications interface 724. The communications interface 724 may be configured to allow software and data to be transferred between the computer system 700 and external devices. Exemplary communications interfaces 724 may include a modem, a network interface (e.g., an Ethernet card), a communications port, a PCMCIA slot and card, etc. Software and data transferred via the communications interface 724 may be in the form of signals, which may be electronic, electromagnetic, optical, or other signals as will be apparent to persons having skill in the relevant art. The signals may travel via a communications path 726, which may be configured to carry the signals and may be implemented using wire, cable, fiber optics, a phone line, a cellular phone link, a radio frequency link, etc.

The computer system 700 may further include a display interface 702. The display interface 702 may be configured to allow data to be transferred between the computer system 700 and external display 730. Exemplary display interfaces 702 may include high-definition multimedia interface (HDMI), digital visual interface (DVI), video graphics array (VGA), etc. The display 730 may be any suitable type of display for displaying data transmitted via the display interface 702 of the computer system 700, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 708 and secondary memory 710, which may be memory semiconductors (e.g., DRAMs, etc.). These computer program products may be means for providing software to the computer system 700. Computer programs (e.g., computer control logic) may be stored in the main memory 708 and/or the secondary memory 710. Computer programs may also be received via the communications interface 724. Such computer programs, when executed, may enable computer system 700 to implement the present methods as discussed herein. In particular, the computer programs, when executed, may enable processor device 704 to implement the methods illustrated by FIGS. 3-6, as discussed herein. Accordingly, such computer programs may represent controllers of the computer system 700. Where the present disclosure is implemented using software, the software may be stored in a computer program product and loaded into the computer system 700 using the removable storage drive 714, interface 720, and hard disk drive 712, or communications interface 724.

Techniques consistent with the present disclosure provide, among other features, systems and methods for consumer behavior. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for unblocking spam email messages, comprising:
storing, in an email database, a plurality of email data entries, wherein each email data entry includes data related to an email message including at least message data, content data, and an indication of spam;
receiving, by a receiving device, consumer data associated with one or more consumers, wherein the consumer data is based on transaction data for one or more payment transactions involving the associated one or more consumers;
identifying, in the email database, one or more email data entries where the included content data corresponds to the received consumer data; and
transmitting, by a transmitting device, at least the message data included in each of the identified one or more email data entries.

2. The method of claim 1, wherein
the received consumer data includes a consumer behavior model corresponding to the associated one or more consumers, the consumer behavior model based on the transaction data for one or more payment transactions involving the associated one or more consumers, and
correspondence between the included content data of the one or more email data entries and the received consumer data is based on at least the consumer behavior model.

3. The method of claim 1, wherein
the consumer data includes specified content data, and
the content data included in each of the identified one or more email data entries corresponds to the specified content data.

4. The method of claim 1, wherein
the content data includes at least an email address associated with a destination of the related email message, and
the received consumer data includes one or more consumer email addresses.

5. The method of claim 1, wherein the one or more consumers are included in a microsegment of consumers.

6. The method of claim 1, wherein the consumer data includes data related to feedback provided by the associated one or more consumers.

7. A method for unblocking spam email messages, comprising:
storing, in an email database, a plurality of email data entries, wherein each email data entry includes data related to an email message including at least message data, content data, and an indication of spam;
storing, in a transaction database, a plurality of transaction data entries, wherein each transaction data entry includes data related to a payment transaction involving a consumer including at least transaction data;
identifying, by a processing device, a consumer behavior model associated with the consumer based on the transaction data included in each transaction data entry stored in the transaction database;
identifying, in the email database, one or more email data entries based on a correspondence between the included content data and the identified consumer behavior model; and
transmitting, by a transmitting device, at least the message data included in each of the identified one or more email data entries.

8. The method of claim 7, wherein the consumer is one of a microsegment of consumers.

9. The method of claim 7, wherein the transaction data includes at least one of: product data, merchant data, and consumer data.

10. The method of claim 7, further comprising:
receiving, by a receiving device, feedback data from the consumer, wherein
the identified consumer behavior model associated with the consumer is further based on the received feedback data.

11. A system for unblocking spam email messages, comprising:
an email database configured to store a plurality of email data entries, wherein each email data entry includes data related to an email message including at least message data, content data, and an indication of spam;
a receiving device configured to receive consumer data associated with one or more consumers, wherein the consumer data is based on transaction data for one or more payment transactions involving the associated one or more consumers;
a processing device configured to identify, in the email database, one or more email data entries where the included content data corresponds to the received consumer data; and
a transmitting device configured to transmit at least the message data included in each of the identified one or more email data entries.

12. The system of claim 11, wherein
the received consumer data includes a consumer behavior model corresponding to the associated one or more consumers, the consumer behavior model based on the transaction data for one or more payment transactions involving the associated one or more consumers, and
correspondence between the included content data of the one or more email data entries and the received consumer data is based on at least the consumer behavior model.

13. The system of claim 11, wherein
the consumer data includes specified content data, and
the content data included in each of the identified one or more email data entries corresponds to the specified content data.

14. The system of claim 11, wherein
the content data includes at least an email address associated with a destination of the related email message, and
the received consumer data includes one or more consumer email addresses.

15. The system of claim 11, wherein the one or more consumers are included in a microsegment of consumers.

16. The system of claim 11, wherein the consumer data includes data related to feedback provided by the associated one or more consumers.

17. A system for unblocking spam email messages, comprising:
an email database configured to store a plurality of email data entries, wherein each email data entry includes data related to an email message including at least message data, content data, and an indication of spam;
a transaction database configured to store a plurality of transaction data entries, wherein each transaction data entry includes data related to a payment transaction involving a consumer including at least transaction data;
a processing device configured to
identify a consumer behavior model associated with the consumer based on the transaction data included in each transaction data entry stored in the transaction database, and
identify, in the email database, one or more email data entries based on a correspondence between the included content data and the identified consumer behavior model; and
a transmitting device configured to transmit at least the message data included in each of the identified one or more email data entries.

18. The system of claim 17, wherein the consumer is one of a microsegment of consumers.

19. The system of claim 17, wherein the transaction data includes at least one of: product data, merchant data, and consumer data.

20. The system of claim 17, further comprising:
a receiving device configured to receive feedback data from the consumer, wherein
the identified consumer behavior model associated with the consumer is further based on the received feedback data.
